(19) United States
(12) Patent Application Publication
(10) Pub. No.: US 2007/0282783 A1
(43) Pub. Date: Dec. 6, 2007

(54) AUTOMATICALLY DETERMINING A SENSITIVITY LEVEL OF A RESOURCE AND APPLYING PRESENTATION ATTRIBUTES TO THE RESOURCE BASED ON ATTRIBUTES OF A USER ENVIRONMENT

(76) Inventor: Mona Singh, Cary, NC (US)

Correspondence Address: SCENERA RESEARCH, LLC, 111 Corning Road, Suite 220, Cary, NC, 27518, US

(21) Appl. No.: 11/421,366

(22) Filed: May 31, 2006

(51) Int. Cl. G06F 17/30

(52) U.S. Cl. 707/1

(57) ABSTRACT

A method and system is provided for automatically determining a sensitivity level of a resource and automatically applying presentation attributes to a resource based on attributes of a user environment in which the resource is presented. Aspects of this embodiment include monitoring attributes of a user environment in which a first instance of information related to a resource is presented to a user; determining attributes of the resource for which the first instance of information is presented; detecting a user-initiated change in a presentation attribute of the instance of information; following detection of the user-initiated change in the presentation attribute, storing the user environment attributes and the changed presentation attribute in association with the resource; and automatically determining a sensitivity level of the resource based on the detected user-initiated change in the presentation attribute and the user environment attributes.

### BACKGROUND

As computing devices become mobile, protection of information that might be sensitive or confidential in nature becomes increasingly important. The information in general can be a document, some digital media, or any other data exposed by an application.

While a significant amount of work has been done on ways to protect information that has been determined to be sensitive, the determination of the sensitivity of resources such as documents or audio files is at present, manually performed by the user. Based on the sensitivity assigned by a user, appropriate actions can be taken to protect information, such as encrypting the information.

However, the burden of determining whether or not the information is sensitive (and sensitive to what extent or purposes) falls entirely on the user. Even if the user can manually set the sensitivity level of the information, a manual setting will be static. For example, a user may determine that the document he is working on has low sensitivity when he begins composing it. But it may happen that as time goes by the document may become more sensitive or the user may enter new environments where the document may become sensitive. The burden would be on the user to update the sensitivity level. Typically, the level of sensitivity accorded to information depends upon the environment in which the user wishes to use it. Similar problems occur with audio content.

Another problem is that once a user opens a document or file, the user may change the way in which the file is displayed (or played) based on the sensitivity or confidentiality of the file and the user's environment. For example, the user may open and view a confidential text document while at home, but in a public area such an airplane, the user may adjust the display of the resource to preserve its confidentiality by reducing its display window, lowering the volume, setting a smaller font, using less magnification, dimming the display, and/or tilting the display from others, for instance. Unfortunately, conventional systems require the user to make such adjustments manually for each file displayed and according to the particular environment in which the user is present.

### SUMMARY

A method and system is provided for automatically determining a sensitivity level of a resource. Aspects of this embodiment include monitoring attributes of a user environment in which a first instance of information related to a resource is presented to a user; determining attributes of the resource for which the first instance of information is presented; detecting a user-initiated change in a presentation attribute of the instance of information; following detection of the user-initiated change in the presentation attribute, storing the user environment attributes and the changed presentation attribute in association with the resource; and automatically determining a sensitivity level of the resource based on the detected user-initiated change in the presentation attribute and the user environment attributes.

In a further embodiment, a method and system is provided for automatically applying presentation attributes to a resource based on attributes of a user environment in which the resource is presented. Aspects of an exemplary embodiment include monitoring attributes of a user environment in which a first instance of information related to a resource is presented to a user; detecting a change in an attribute of the user environment; detecting a user-initiated change in a presentation attribute of the first instance of information following the detected change in the user environment attribute, the user-initiated change related to a presentation of the first instance of information; associating the changed user environment attribute and the changed presentation attribute with the resource; detecting a second instance of information related to the resource being presented to the user; and providing for the changed presentation attribute to be applied to the second instance of the information related to the resource when the associated user environment attribute is detected.

According to the method and system disclosed herein, aspects of the exemplary embodiments alleviate the need for a user to manually assign sensitivity levels to resources, and the system automatically replicates a user's actions with respect to the presentation of a resource under specific contextual conditions.

### BRIEF DESCRIPTION OF SEVERAL VIEWS OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a block diagram illustrating a system for automatically applying presentation attributes to a resource in accordance with an exemplary embodiment.

FIG. 2 is a flow diagram illustrating a process for automatically applying presentation attributes to a resource based on the attributes of the user environment in accordance with the exemplary embodiment

FIG. 3 is a table illustrating an exemplary database schema for the sensitivity database.

FIG. 4 is a flow diagram summarizing the process elucidated above for automatically determining the sensitivity of a resource in accordance with an exemplary embodiment.

FIG. 5 is a block diagram illustrating components of an electronic device incorporating the system shown in FIG. 1.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

A preferred embodiment provides a method and system for automatically applying presentation attributes to a resource based on attributes of a user environment in which the resource is presented. Actions the user takes with respect to a resource that is presented by an electronic device are correlated with the environment in which the actions are taken, and presentation attributes are automatically applied to the resource based on previous user actions taken with respect to that resource or a related resource in similar environments.

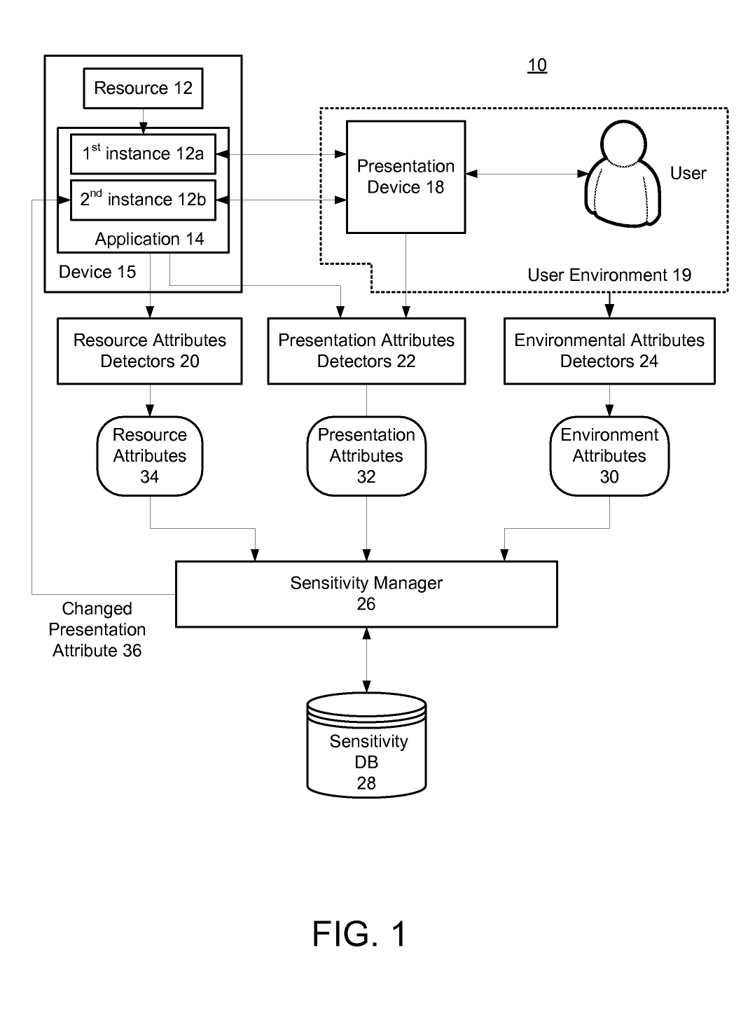

FIG. 1 is a block diagram illustrating a system for automatically applying presentation attributes to a resource in accordance with an exemplary embodiment. The system 10 includes a resource 12 that is being presented by an application 14 to a user through a presentation device 18. The application 14 may represent any type of program running on an electronic device 15 that is capable of presenting information associated with the resource 12. The electronic device 15 may represent any type of device including desktop computers, laptop computers, personal digital assistants (PDA), cell phones, camera phones, MP3 players, video players, and game players, for instance. The application 14 may represent any type of software including a word processor, a spreadsheet, an email program, a browser, an image editing program, a music and/or video player, a game, and a database program, for instance. The presentation device 18 may represent any type of output device capable of presenting the resource 12 to the user including a display, a speaker, a printer, and an olfactory output device, for example.

As used herein, the resource 12 is a source of content or information that can be presented in multiple instances to the user. FIG. 1 shows first and second instances of information 12a and 12b related to the resource 12 being presented to the user. The second instance of information 12b can be either 1) information for the same resource 12 being presented a second time (e.g., the resource is displayed in two separate windows), or 2) information being presented for a second resource that is related to the first resource (e.g., both resources are the same type, such as MSWORD files). The resource 12 may be stored as a file, which may be represented via an icon and/or resource name. The resource 12 may comprise any media type, including text, image, audio, video, application, and database. The content of the resource 12 may comprise software or data, including network component information. Examples of application resources include programs, utilities or even smaller elements within a program. Examples of network resources include servers and printers in the network. The resource 12 may reside on the user's local system or remotely over a network (in which case, the remote resource is typically represented as a hyperlink on the local system). Typically, the device 15 includes many such resources 12. Although in an exemplary embodiment, the first instance of information 12a is presented to the user first, followed sometime later by presentation of the second instance of information 12b, nothing prevents the first and second instances of information 12a and 12b being presented at the same time.

As described above, once the resource 12 is presented to the user, the user may change the way in which the resource is presented based on the sensitivity or confidentiality of the resource and the user's environment 19. For example, the user may open and view a confidential text document while in his or her office at work, but outside the office, the user may adjust the presentation of the resource 12 to preserve its confidentiality by reducing its display window, setting a smaller font, reducing the volume, using less magnification, dimming the display, and/or tilting the display from others, for instance. In this context, the user interacting with the first instance of information 12a related to the resource 12 may be the same or different user as the user interacting the second instance of information 12b (the user's identity may be optionally determined by conventional login identification). Unfortunately, conventional systems require the user to make presentation adjustments manually for each resource 12, or instance of thereof, presented and according to the particular environment in which the user and/or resource is presented.

According to the exemplary embodiment, the system 12 is provided with resource attributes detectors 20, presentation attributes detectors 22, environmental attributes detectors 24, a sensitivity manager 26, and a sensitivity database 28. In an exemplary embodiment, the resource attributes detectors 20 determine a resource attributes 24 related to the resource 12. The presentation attributes detectors 22 monitor presentation attributes, such as the attribute 32 associated with the presentation of the resource 12. The environmental attributes detectors 24 monitor environment attributes 30 in the user environment 19. In conjunction with one or more of the detectors 20, 22 and 24, the sensitivity manager 26 is capable of automatically applying a changed presentation attribute 36 to the resource 12 based on the environment attributes 30 of the user environment 19 in which the resource 12 is presented and on past user-initiated presentation behavior, as described below.

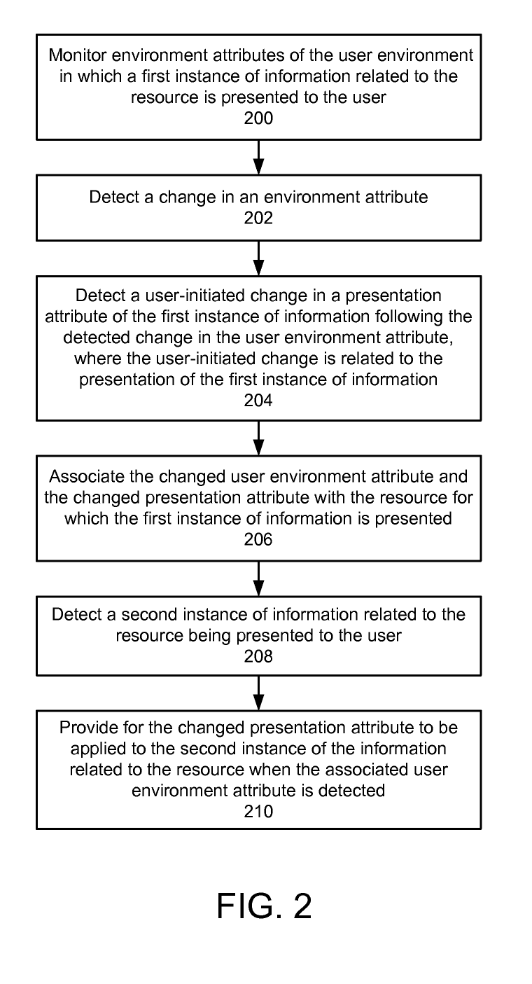

FIG. 2 is a flow diagram illustrating a process for automatically applying presentation attributes to a resource based on the attributes of the user environment in accordance with the exemplary embodiment. Referring to both FIGS. 1 and 2, the process begins in step 200 by monitoring environment attributes 30 of the user environment 19 in which a first instance of information 12a related to the resource 12 is presented to the user. As used herein, an attribute is an element of data that is typically changeable over time. The environment attributes 30 detected by the environmental attributes detectors 24 may include a location of the user; ambient environmental conditions at the location of the user; a presence of people in a vicinity of the user; and identities of people in the vicinity of the user.

In step 202, the sensitivity manager 26 detects a change in one of more environment attributes 30. By continually receiving and monitoring environment attributes 30 from the environmental attributes detectors 24, the sensitivity manager 26 can detect changes in those attributes 30 by comparing current attribute values with previous values.

In step 204, the sensitivity manager 26 detects a user-initiated change in a presentation attribute 32 of the first instance of information 12a following the detected change in the user environment attribute 30. The user-initiated change is related to the presentation of the first instance of information 12a. Again, the sensitivity manager 26 can detect changes by continually receiving and monitoring presentation attributes 32 from the presentation attributes detectors 22 and comparing current attribute values with previous values. Detecting the user-initiated change in the presentation attribute 32 may include detecting physical changes made to the presentation device 18 and/or physical changes made to a presentation space presented by the presentation device 18.

In an exemplary embodiment, a presentation space may include an operating or application window displayed on a monitor, an icon, or even a sheet of paper output from a printer, for example. Physical changes made to the presentation device 18 may include changes to brightness and contrast; changes to audio volume; changes to angle of tilt; changes to power; changes to headphones connection status; and olfactory changes, for example. In contrast, physical changes made to the presentation space presented by the presentation device 18 may include: changes to size; changes to magnification; changes to overlap with at least one other presentation space; and changes to minimization/maximization.

In one embodiment, the process also includes determining resource attributes 34 of the resource 12 using the resource attributes detector 20. In an exemplary embodiment, the resource attributes 34 of the resource 12 that may be determined include: a name of the resource 12; a path of the resource 12; a MIME type of the resource 12; a uniform resource 12 locator (URL) associated with the resource 12; and determining whether the resource 12 is a communication message or is attached to a communication message, and if so, further identifying the sender and/or recipient of the communication message.

In step 206, the changed user environment attribute 30 and the changed presentation attribute 32 are associated with the resource 12 for which the first instance of information 12a is presented. In an exemplary embodiment, once the sensitivity manager 26 detects changes to the user environment attribute 30 and the presentation attribute 32, the sensitivity manager 26 stores the user environment attribute 30 and the changed presentation attribute 32 in a record for the resource 12. In one embodiment, the record for the resource 12 may be created when the resource attributes 34 are first received. In a second embodiment, the record for the resource 12 may be created after the detection of changed user environment attributes 30 or changed presentation attributes 32.

In a preferred embodiment, the application(s) 14 that manage the presentation of information registers with, and reports the presentation to the sensitivity manager 26. The application 14 could receive a specification of what user-initiated changes are to be monitored and reported to the sensitivity manager 26. The sensitivity manager 26 may then correlate the resource attributes 34 from the application 14 (via the resource attribute detectors 20) with the detected presentation attributes 32 and environment attributes 32, and store the pertinent information in the sensitivity database 28. In an alternative embodiment, all user-initiated changes to the presentation attributes 32 pertaining to the resource 12 may be sent to the sensitivity manager 26 and the sensitivity manager 26 can select the pertinent information to be stored in the sensitivity database 28.

In step 208, the second instance of information 12b related to the resource 12 being presented to the user is detected. The second instance of information 12b may reside on the same or a different device 15 than the first instance of information 12a; and the user may be in the same or different user environment 19 than when the first instance of information 12a was presented. As described above, the second instance of information 12b can be the same as the first instance of information 12a, or can include different information, but nevertheless is related to the same resource 12. In addition, the second instance of information 12b may be presented by the same or different application 14 and/or presentation device 18 that presented the first instance of information 12a.

As the second instance of information 12b is presented, the presentation attributes detectors 22 and environmental attributes detectors 24 input the presentation attributes 32 and environment attributes 30, respectively, to the sensitivity manager 26 for monitoring and storing attributes of the user environment 19 in which the second instance of information 12b related to the resource 12 is or will be presented to the user. The resource attributes 34 corresponding to the resource 12 for which the second instance of information 12b is or will be presented are determined by the resource attributes detectors 20. Step 206 is repeated for each instance of information presented, thereby iteratively storing data including the changed environment attribute 30 and the changed presentation attribute 32 along with the resource attributes 34 corresponding to each instance of information related to the resource 12 presented. The second instance of information 12b may be related to a resource 12 for which information has previously been presented, and therefore will have a corresponding entry in the sensitivity database 28, or could be related to a new resource 12 for which no entries exist in the sensitivity database 28, in which case, one is created.

In step 210, the sensitivity manager 26 provides for the changed presentation attribute 36 to be applied to the second instance of the information 12b related to the resource 12 when the associated user environment attribute 30 is detected. In one embodiment, the changed presentation attribute 36 is automatically applied to the second instance of information 12b. In a second embodiment, the changed presentation attribute 36 is applied to the second instance of information 12b after prompting the user whether to apply the changed presentation attribute 36. Application of the changed presentation attribute 36 to the second instance of information 12b may occur when the second instance of information 12b is to be presented, or after the second instance of information, 12b has already been presented.

According to the exemplary embodiment, the resource attributes 34 of the resource 12 for which the second instance of information 12b is presented and the monitored environment attributes 30 of the user environment in which the second instance of information 12b is or will be presented to the user are correlated with the iteratively stored data in the sensitivity database 28. If the correlation of the resource attributes 34 of the resource 12 for which the second instance of information 12b is presented and the monitored environment attributes 30 in which the second instance of information is or will be presented to the user with the stored resource attributes 30 of the resource 12 and the associated stored changed environment attributes 30 reaches a predetermined sensitivity level, then the stored changed presentation attribute 36 associated with the resource is automatically applied to the second instance of information 12b.

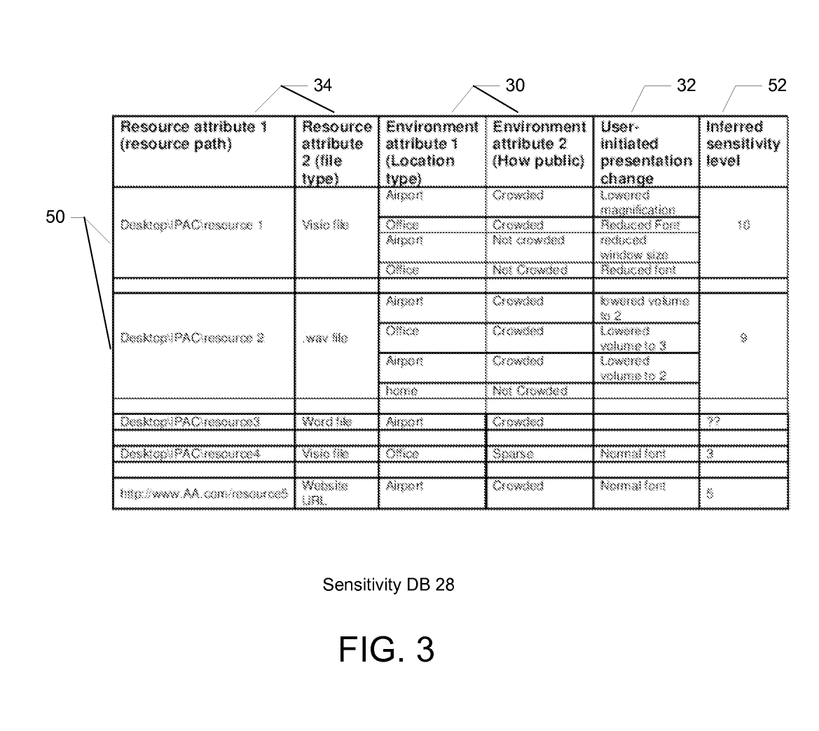

FIG. 3 is a table illustrating an exemplary database schema for the sensitivity database 28. In an exemplary embodiment, the sensitivity database 28 includes one or more records 50 for identified resources 12. Each record includes columns for storing resource attributes 34 of the identified resource 12, the environment attributes 30 existing at the time of resource presentation, and the user-initiated presentation attributes 32. In the example shown, resource attributes 34 used to identify the resource 12 include a pathname in the first column, and a file type of the resource 12 in the second column. Further, each identified resource 12 may have multiple stored environment attributes 30 corresponding to the user-initiated presentation attributes 32.

In the example shown, the stored environment attributes 30 include location type and a descriptor of how public for location. Each new combination of changed environment attributes 30 may be recorded (e.g., Office Crowded; Office Not Crowded). In an exemplary embodiment, the sensitivity manager 26 may be configured to abstract received environment attributes 30 into the location type and the public descriptor. For example, GPS location data may be used to query a mapping service to obtain address information, and the address information may be used to query an online service for the location type, e.g. airport. The public descriptor can be abstracted by receiving a count of the people present in the user's vicinity and labeling that number as crowded or not crowded based on predetermined thresholds for the type of location.

According to a further embodiment, the sensitivity manager 26 and sensitivity database 28 are further configured to determine automatically an inferred sensitivity level 52 of a presented resource 12. In the table shown, the inferred sensitivity level 52 depends on the user-initiated change in presentation attributes 32 and the value of the sensitivity level 52 prior to the user-initiated change. In the exemplary embodiment, the sensitivity manager 26 may increase the sensitivity level 52 of the resource 12 when the physical changes made to the presentation device 18 include the following: lowered brightness or contrast; lowered audio volume; input of headphones; decreased angle of tilt of a display about a horizontal axis, such as the closing of a laptop display; and increased angle of tilt away of a display from others in the vicinity of the user. The sensitivity manager 26 may increase the sensitivity level 52 of the resource 12 when the physical changes made to the presentation space include the following: decreased presentation space size; decreased magnification; increased overlap with at least one other presentation space; and frequent minimization. The sensitivity level 52 may be decreased when the opposite physical changes to the presentation device 18 and/or the presentation space are detected.

In an exemplary embodiment, a point scale may be used to represent sensitivity. For example, the sensitivity level 52 may be represented by a point scale ranging in values from 1 to 10, with 10 being the most sensitive. However, any enumeration scheme for the sensitivity level 52 may be used. The sensitivity manager 26 may be configured to increase the sensitivity level 52 (e.g., by 1 up to a maximum of 10) for each change in the presentation attributes 32 that corresponds to increased sensitivity; and to decrease the sensitivity level 52 (e.g., by 1 down to a minimum of 1) for each change in the presentation attributes 32 that corresponds to reduced sensitivity. For example, if a user opens a document on an electronic device while at the airport when it is crowded and he lowers the magnification of the window in which the document is displayed on three separate occasions, only one record 50 will be recorded for that resource 12 because of the shared attribute values (Airport; Crowded; Lowered Magnification), but the inferred sensitivity level 52 will be updated for each occurrence.

According to the exemplary embodiment, the sensitivity manager 26 uses the sensitivity database 28 to continually predict the sensitivity level 52 for the current resource 12 for which information is being presented in relation to the user's changing environment, e.g., as people enter or leave the vicinity of the user or as the user's location changes. This is accomplished by correlating the resource attributes 34 of the current resource and the user's environment attributes 30 with previously stored resource attributes 34 and environment attributes 30 in the sensitivity database 28 to predict the sensitivity level 52 of the current resource 12. If the correlation of the resource attributes 34 of the current resource and current environment attributes 30 with the resource attributes 34 of a resource stored in the sensitivity database 28 along with its corresponding environment attributes 30 reaches a predetermined level (i.e., if a sufficiently matching database record is found), then the sensitivity manager 26 selects the user-initiated presentation attribute(s) 32 associated with the correlated or matching resource entry in the database 20 to either suggest to the user the presentation attribute change(s) 32 or to automatically perform the presentation attribute change(s) based on configuration settings.

For example, assume that the third record 50 in the table of FIG. 2 corresponds to a resource for which an instance of a information is currently being presented and has a missing sensitivity level 52, which is shown in the table as a ?? value. According to an exemplary embodiment, the missing sensitivity level value 52 for that record 50 can be inferred by correlating the attributes of the current record with a record having the same or similar attributes for which a sensitivity level 52 is available. For example, the third record 50 in the table having the missing sensitivity value has a resource type of “Word file” and environment attributes 30 (Airport; Crowded). It could be determined that the first record 50 in the table is a match for the third record 50 even though the two identified resources are of two different types because the resources 12 share the same resource paths (Desktop/ABC) and have matching environment attributes 30 (Airport; Crowded). Therefore, the sensitivity level 52 and/or the user-initiated presentation attribute 32 from the first record 50 could be applied as the values for sensitivity level 52 and user-initiated presentation attribute 32 for the third record 50.

Once a matching record 50 is found for a current resource, the sensitivity manager 26 may be configured to perform presentation attribute change(s) on the corresponding presented instance of information, such as the following: reduce the brightness of the screen; reduce the volume of the speaker; reduce the magnification of the window; reduce the size of the icon; reduce the application window size, possibly even minimizing the window; pop up a window covering the information, and prompting the user of what action to take by displaying a list of recommendations, and/or showing the unfamiliar faces near by and asking the user to perform an action.

In one embodiment, the sensitivity level 52 can be used for automatically performing actions (in addition to automatically applying presentation attributes 32) on resources 12 having predetermined sensitivity levels 12. For example, the sensitivity level 52 of resources 12 may be used for routing, encryption, and access control. An example of routing is the automatic routing of a file with a high sensitivity level 52 using a secure server. An example of encryption is to encrypt a document having a high sensitivity level 52, but not encrypting a document having a low sensitivity level 52. An example of access control is applying higher levels of user access requirements to a document having a high sensitivity level 52.

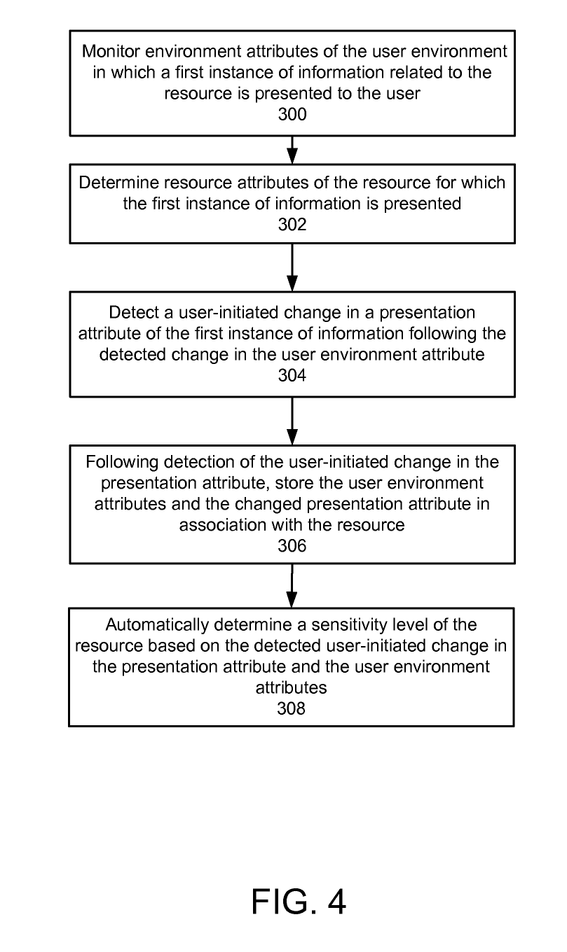

FIG. 4 is a flow diagram summarizing the process elucidated above for automatically determining the sensitivity of a resource in accordance with an exemplary embodiment. The process begins in step 300 by monitoring attributes of a user environment in which a first instance of information related to a resource is presented to a user. As discussed above, this is accomplished via the environmental attributes detectors 24 in conjunction with sensitivity manager 26. In step 302, the application 14 and/or the resource attributes detectors 20 determine resource attributes 34, such as path and MIME type, of the resource 12 for which the first instance of information is presented. In step 304, the sensitivity manager 26, in conjunction with the presentation attributes detectors 22, detects a user-initiated change in a presentation attribute 32 of the instance of information. The user-initiated change in the presentation attribute 32 may include a physical change made to the presentation device 18 and/or physical changes made to the presentation space presented by the presentation device 18. In step 306, following detection of the user-initiated change in the presentation attribute 32, the user environment attributes 30 and the changed presentation attribute 32 are stored in association with the resource 12, preferably in a record for the resource 12 in the sensitivity database 28. In step 308, a sensitivity level 52 of the resource 12 is automatically determined based on the detected user-initiated change in the presentation attribute 32 and the user environment attributes 30.

The following example user scenarios are provided to illustrate and clarify the features, functionality and advantages or the exemplary embodiments:

### EXAMPLE 1

Assume an employee of ABC has an important company document open on his desktop equipped with the sensitivity manager system while working at the ABC office in Cary, N.C. The system detects a number of faces or people (via short range radio ID cards for example) in the vicinity and within reading range of the document, but the ABC employee does not demonstrate any behavior that indicates that the document has high privacy.

Consider that the same ABC employee is now located at an airport and opens up the same document on a laptop. The laptop is also equipped with a sensitivity manager system, which shares sensitivity data with the user's desktop. The system on the laptop detects that the user's location has changed (e.g., based on GPS or different IP address than usual). Due to the user's environment, the user shrinks the document window and lowers magnification on the text. The system compares the users presentation changes with respect to the document to the sensitivity data in the sensitivity database and observes that the way the user presents the document in the current location and environment has changed and is different than at the office location and environment. Based on the exemplary embodiments, the system determines that the document may be safely exposed within the company site and in the vicinity of other company employees. However, the document may not be exposed in an off-site setting where there are unfamiliar faces present. The next time the user opens the document in an off-site setting, the system will apply the presentation changes the user previously made to the document in that setting.

### EXAMPLE 2

Assume that an employee from DEF Systems subscribes to a daily audio blog that helps him keep track of the various divisions within his company. The blogs tend to be fairly long and the user usually listens to them at the end of the day. Lately, he has been running out of time at work to listen to the blogs, so he listens to the audio blogs on the train ride home using his laptop. However, due to the somewhat sensitive nature of the blogs, he tends to lower the volume of the laptop and reduces the brightness of the screen when on the train so that people in his vicinity are unable to follow the blog along with him. He does not perform these actions related to the presentation of the blog information when receiving the information at work. The sensitivity manager system once installed in his device will be able to understand his intent and automatically perform these presentation changes for him when on the train or other location in close proximity to many people, but will not alter the presentation of the audio blogs when in the work environment.

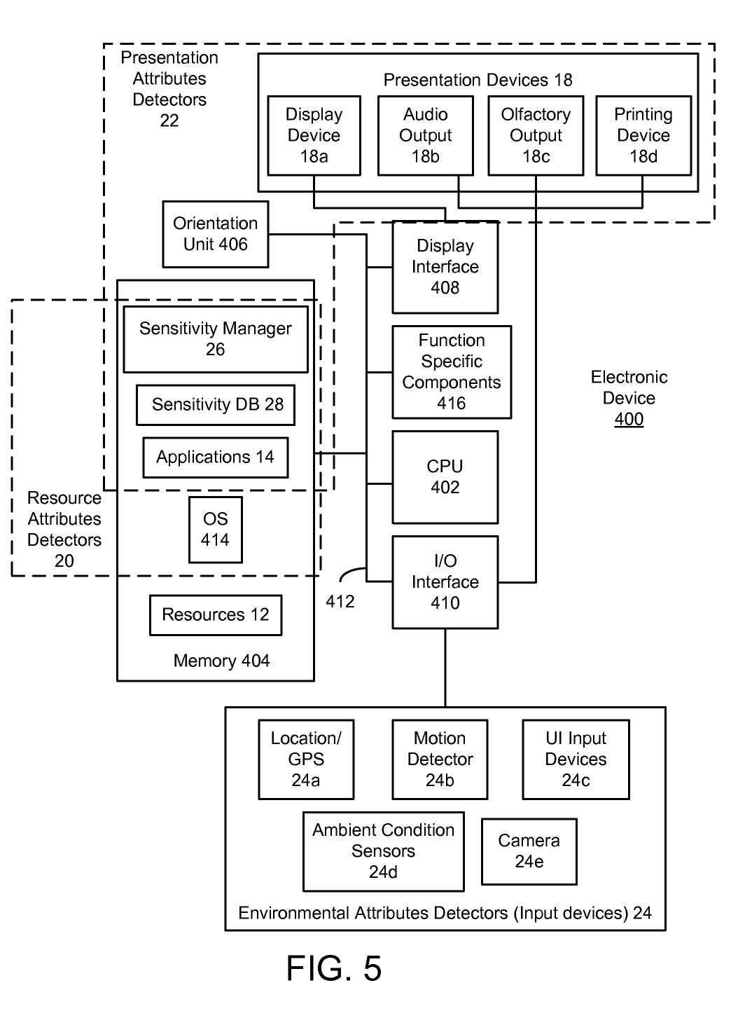

FIG. 5 is a block diagram illustrating components of an electronic device 400 incorporating the system shown in FIG. 1, where like components have like reference numerals. Hardware components of the electronic device 400 include a central processing unit (CPU) 402, memory 404, one or more presentation devices 18, an orientation unit 406, a display interface 408, and input/output (I/O) interface 410, one or more environmental attributes detectors 24, and function specific components 416, which are all coupled to a system bus 412. Software components of the electronic device 400 reside in memory 404 and include the sensitivity manager 26, the sensitivity database 28, one or more applications 14, an operating system (OS) 414 and one or more resources 12.

In a preferred embodiment, CPU 402 is preferably a microprocessor, but may be implemented as one or more DSP's (digital signal processor) or ASIC's (Application Specific Integrated Circuit), and is preferably capable of concurrently running multiple software routines to control the various processes of the electronic device 400 within a multithreaded or multiprocessing environment. The memory 404 is preferably a contiguous block of dynamic or static memory that may be selectively allocated for various storage functions, such as executing various software applications 14. The memory 404 may include read-only memory and random access memory. The function specific components 416 include hardware for supporting the various functions of the device 400, such as cellular components for supporting a cell phone function, or a joystick and buttons for supporting a game system, for instance.

The OS 414 installed in the device 400 is the master control program that runs the device 400, and may comprise commercial operating systems such as WINDOWS XP or LINUX for PCs, or the SYMBIAN OS for smart phones, or a proprietary operating system. Several applications 14 may be run on top of the OS 414, such as MICROSOFT WORD, INTERNET EXPLORER, and so on. The applications 14 generally retrieve and present resources 12 (or instances thereof) on one or more of the presentation devices 18.

In this embodiment, the sensitivity manager 26 is shown implemented as a program residing in memory 404 that is separately executable by the CPU 402. The sensitivity manager 26 and sensitivity database 28 may be implemented as a single software module or multiple software modules and may be configured to interoperate with the electronic device 400 using a variety of methods. In one embodiment, the sensitivity manager 26 may be developed as a plug-in for common applications 14 on the device 400, such as MICROSOFT OFFICE, portable document format (PDF) applications, image applications, database applications, and communications applications, for example. In another embodiment, the sensitivity manager 26 may be developed as a set of application programming interfaces (APIs) that developers of applications 14 can use. In a further embodiment, the sensitivity manager 26 may be developed as a component of an operating system of a computing device.

In yet a further embodiment, the sensitivity manager 26 and/or the sensitivity database 28 may be implemented as an application running on a server over a network. The device 400 could be configured to receive inputs from the presentation attributes detectors 22, the resource attributes detectors 20, and environmental attributes detectors 24 and pass the inputs to the server. This organization would be beneficial in cases where the system needs to be deployed on a handheld device having limited resources.

The presentation devices 18 are responsible for presenting the resources 12 to the user, and may represent one or more of any type of output peripheral, including display device 18a (e.g., a monitor, touchscreen, or projector), audio output 18b, olfactory output 18c, and a printing device 18d. The display device 18a is coupled to the system bus via the display interface 408. The display interface 408 accesses the memory 404 and transfers display data to the display device 18a for display. The audio output 18b typically comprises a speaker and/or headphones for producing audio. The olfactory output 18c is capable of producing various scents, and the print device 18d outputs prints.

The I/O interface 410 allows communication to and from the electronic device 400. The I/O interface 410 interfaces with the components of the user interface 12, including the audio output 18b, olfactory output 18c, and print device 18d, as well an UI input devices 24c, such as a microphone, a keyboard, a pointing device, buttons, identification card readers, and the like. The I/O interface 410 also permits external network devices, such as a server (not shown), to connect to and communicate with the device 400.

According to the exemplary embodiment, the electronic device 400 includes means for detecting resource attributes of a present resource 12. For example, the electronic device 400 includes resource attributes detectors 20, which may comprise one or more of the operating system 414, the application 14 presenting the resource 12, and the sensitivity manager 26. For example, the identity of the resource 12 may be provided by the application 14, while resource attributes such as the filename, path and MIME type, may be obtained from the operating system 414 by either the application 14 or the sensitivity manager 26.

The electronic device 400 further includes means for detecting user-initiated changes to presentation attributes. For example, the electronic device 400 includes presentation attribute detectors 22, which may comprise the orientation unit 406, one or more of the presentation devices 18, the sensitivity manager 26, and the applications 14. If the device 400 has an integrated display device 18a, then the orientation unit 406 senses the current physical position of the device 400 and sends orientation signals to the CPU 24 that are used to determine the current orientation of the device 400. If the device 400 has a display device 18a that is movable relative the device 400, e.g., the display of a laptop or desktop, the orientation unit 406 is preferably integrated into the display device 18a and senses the current physical position of the display device 18a. For desktop displays, the orientation unit 406 preferably senses tilt of the display about a vertical axis (i.e., left/right tilt). For laptop displays, the orientation unit 406 preferably senses tilt of the display about both the vertical axis and a horizontal axis (i.e., open/close tilt). Construction and functionality of orientation units are well-known in the art and outside the scope of this disclosure.

The sensitivity manager 26 may be configured to obtain presentation attributes 32 from the orientation unit 406, the audio output 18b and the olfactory output 18c from the operating system 414; and configured to obtain display and print settings for the display device 18a and printing device 18d, respectively, from the application 14 displaying and/or printing resource 12 to determine changed presentation attributes. Alternatively, components and applications 14 of the device 400 may be configured to register with the sensitivity manager 26 and to send specified presentation attributes 32 to the sensitivity manager 26 based on configuration settings.

The electronic device 400 further includes means for detecting environment attributes 30 of the user environment 19. For example the electronic device 400 may include environmental attributes detectors 24, which may include one or more input devices such as a location/global positioning system (GPS) 24a, a motion detector 24b, the user interface input devices 24c, ambient condition sensors 24d, and a camera 24e. The location/global positioning system (GPS) 24a determines user location. In one embodiment, may be integrated with the electronic device 400, while in a second embodiment, the location/global positioning system 24a is external and coupled to the electronic device 400 via a wired or wireless network (not shown). For example, in a wireless environment, location information may be received from one or more access points, while in a cellular environment, the location information may be received from cell towers.

The motion detector 24b may comprise one more motion detectors located within a vicinity of the user and presentation device 18 for detecting the presence of people. For example, an office building may include a network of motion detectors 24b that are located in rooms of a building or campus, the data from which may be made available over the network.

The ambient condition sensors 24d may comprise any type of sensor for detecting ambient conditions at the location of the user and presentation device 18, such as a thermometer, barometer, altimeter and the like. The ambient condition sensors 24d may be integrated with the device, located on a network, or provided by an external service based on location data. The camera 24e may comprise one or more still or video cameras for capturing images of people. The camera 24e may be integrated with the device 400 or located on a network.

In one embodiment, the sensitivity manager 26 may include an image analyzer for receiving input from the camera 24e and for performing facial recognition to identify people in the vicinity of the user. Similarly, the sensitivity manager 26 may include an audio analyzer for receiving input from a microphone, which is a UI input device 24e, and for performing voice-recognition to identify people in the vicinity of the user.

According to a further embodiment, the sensitivity manager 26 may be configured to alter tactile input. For example, the sensitivity manager 26 may be configured to track and correlate user modification of the properties of touchable elements, and to automatically apply these changes in the future. The properties of touchable elements that may be modified by the user include the following: 1) pressure settings of pressure-sensitive icons representing certain resources on a touchscreen display 18a when they are touched. The settings can be modified to deactivate the icons or to make it more difficult to casually activate the icons as a security precaution. 2) The hotspot area for a button that allows the user to indicate what percentage of the button should be “active”. And 3) the discreteness of key presses that allows the user to specify whether there needs to be a time period between key presses. Not requiring discrete key presses allows the user to slide their finger on the touchable elements without lifting their finger.

A method and system for determining a sensitivity level of a resource and automatically applying presentation attributes to a resource based on attributes of a user environment in which the resource is presented been disclosed. According to the method and system disclosed herein, aspects of the exemplary embodiments alleviate the need for a user to manually assign sensitivity levels to resources, and the system automatically replicates a user's actions with respect to the presentation of a resource under specific contextual conditions.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for automatically determining a sensitivity level of a resource, the method comprising:
monitoring attributes of a user environment in which a first instance of information related to a resource is presented to a user;
determining attributes of the resource for which the first instance of information is presented;
detecting a user-initiated change in a presentation attribute of the instance of information;
following detection of the user-initiated change in the presentation attribute, storing the user environment attributes and the changed presentation attribute in association with the resource; and
automatically determining a sensitivity level of the resource based on the detected user-initiated change in the presentation attribute and the user environment attributes.

2. The method of claim 1 further comprising representing the sensitivity level as a point scale ranging from a minimum value to a maximum value.

3. The method of claim 2 further comprising increasing the sensitivity level for each user-initiated change in the presentation attribute that corresponds to increased sensitivity, and decreasing the sensitivity level for each user-initiated change in the presentation attribute that corresponds to reduced sensitivity.

4. The method of claim 1 further comprising storing the user environment attributes, the changed presentation attribute, and the determined sensitivity level in a record for the resource in a database.

5. The method of claim 4 further comprising storing multiple environment attributes and user-initiated presentation attributes with each identified resource in the database.

6. The method of claim 5 further comprising abstracting the environment attributes into at least one of a location type and a descriptor for the environment, and storing the abstractions in the database.

7. The method of claim 5 further comprising predicting the sensitivity level of a current resource for which information is being presented in relation to the user's changing environment by correlating resource attributes and environment attributes of the current resource with the stored resource attributes and environment attributes in the database to predict the sensitivity level of the current resource.

8. The method of claim 7 further comprising if the correlation of the resource attributes of the current resource and current environment attributes with the stored resource attributes and environment attributes of the resource stored in the database reaches a predetermined level, then selecting the user-initiated presentation attribute associated with the correlated resource entry in the database to at least one of: 1) suggest to the user the presentation attribute change and 2) to automatically perform the presentation attribute change based on configuration settings.

9. The method of claim 1 wherein detecting a user-initiated change in a presentation attribute of the first instance of information includes at least one of detecting physical changes made to a presentation device and physical changes made to a presentation space presented by the presentation device.

10. The method of claim 9 wherein the physical changes made to the presentation device include at least one of:
changes to brightness and contrast;
changes to audio volume;
changes to angle of tilt;
changes to power;
changes to headphones connection status; and
olfactory changes.

11. The method of claim 10 including increasing the sensitivity level of the resource when the physical changes made to the presentation device include at least one of:
lowered brightness or contrast;
lowered audio volume;
input of headphones;
decreased angle of tilt about a horizontal axis; and
increased angle of tilt away from others in the vicinity of the user.

12. The method of claim 9 wherein the physical changes made to the presentation space presented by the presentation device include at least one of:
changes to size;
changes to magnification;
changes to overlap with at least one other presentation space; and
changes to minimization/maximization.

13. The method of claim 12 including increasing the sensitivity level of the resource when the physical changes made to the presentation space include at least one of:
decreased presentation space size;
decreased magnification;
increased overlap with at least one other presentation space; and
frequent minimization.

14. A method for automatically applying presentation attributes to a resource based on attributes of a user environment in which the resource is presented, the method comprising:
monitoring attributes of a user environment in which a first instance of information related to a resource is presented to a user;
detecting a change in an attribute of the user environment;
detecting a user-initiated change in a presentation attribute of the first instance of information following the detected change in the user environment attribute, the user-initiated change related to a presentation of the first instance of information;
associating the changed user environment attribute and the changed presentation attribute with the resource;
detecting a second instance of information related to the resource being presented to the user; and
providing for the changed presentation attribute to be applied to the second instance of the information related to the resource when the associated user environment attribute is detected.

15. The method of claim 14 wherein detecting a user-initiated change in the presentation attribute includes determining attributes of the resource for which the first instance of information is presented.

16. The method of claim 15 wherein determining the attributes of the resource include at least one of:
determining a name of the resource;
determining a path of the resource;
determining a MIME type of the resource;
determining a uniform resource locator (URL) associated with the resource; and
determining whether the resource is a communication message or is attached to a communication message, and if so, further identifying at least one of a sender and a recipient of the communication message.

17. The method of claim 15 wherein associating the changed user environment attribute and the changed presentation attribute with the resource includes iteratively storing data including the changed environment attribute and the changed presentation attribute along with the attributes of the resource corresponding to each instance of information related to the resource presented.

18. The method of claim 17 wherein providing for the changed presentation attribute to be automatically applied to the second instance of the information related to the resource includes:
monitoring attributes of the user environment in which the second instance of information related to the resource is or will be presented to the user; and
correlating attributes of the resource for which the second instance of information is presented and the monitored attributes of the user environment in which the second instance of information is or will be presented to the user with the iteratively stored data.

19. The method of claim 18 wherein if the correlation of the attributes of the resource for which the second instance of information is presented and the monitored attributes of the user environment in which the second instance of information is or will be presented to the user with the stored attributes of the resource and the associated stored changed environment attribute reaches a predetermined level, then automatically applying the stored changed presentation attribute associated with the resource to the second instance of information.

20. The method of claim 14 wherein the second instance of information related to the resource includes at least one of information associated with the resource for which the first instance of information is presented, and information associated with a second resource related to the resource for which the first instance of information is presented.

21. The method of claim 14 wherein detecting a user-initiated change in a presentation attribute of the first instance of information includes at least one of detecting physical changes made to a presentation device and physical changes made to a presentation space presented by the presentation device.

22. The method of claim 21 wherein the physical changes made to the presentation device include at least one of:
changes to brightness and contrast;
changes to audio volume;
changes to angle of tilt;
changes to power;
changes to headphones connection status; and
olfactory changes.

23. The method of claim 21 wherein the physical changes made to the presentation space presented by the presentation device include at least one of:
changes to size;
changes to magnification;
changes to overlap with at least one other presentation space; and
changes to minimization/maximization.

24. The method of claim 14 wherein monitoring attributes of the user environment includes at least one of:
determining a location of the user;
determining ambient environmental conditions at the location of the user;
detecting a presence of people in a vicinity of the user; and
determining identities of people in the vicinity of the user.

25. The method of claim 14 wherein the resource comprises at least one of a text file, a graphics file, an audio file, and a database.

26. An electronic device comprising:
a processor for executing software;
a presentation device coupled to the processor for presenting information;
a memory coupled to the processor, the memory for storing:
at least one software application for presenting first and second instances of information related to a resource via the presentation device, and
a sensitivity manager in communication with the at least one software application;
an environmental attributes detector in communication with the sensitivity manager for monitoring user environment attributes; and
a presentation attributes detector in communication with the sensitivity manager for monitoring presentation attributes;
wherein when executed by the processor, the sensitivity manager functions to:
detect a change in an attribute of a user environment in which the first instance of information related to the resource is being presented;
detect a user-initiated change in a presentation attribute of the first instance of information following the detected change in the user environment attribute, where the user-initiated change is related to the presentation of the first instance of information;
associate the changed user environment attribute and the changed presentation attribute with the resource; and
in response to the second instance of information related to the resource being presented to the user, provide for the changed presentation attribute to be applied to the second instance of the information related to the resource when the associated user environment attribute is detected.

27. The device of claim 26 further including a resource attributes detector for determining resource attributes of the resource.

28. The device of claim 27 wherein the resource attributes detector comprises at least one of an operating system, the at least one software application, and the sensitivity manager.

29. The device of claim 26 wherein the presentation device comprises at least one of a display device, an audio output device, an olfactory output device, and a printing device.

30. The device of claim 29 wherein the presentation attributes detector comprises at least one of an orientation unit for sensing an orientation of at least one of the electronic device and the display device, the presentation device, the at least one software application, and the sensitivity manager.

31. The device of claim 30 wherein the sensitivity manager is configured to obtain presentation attributes from at least one of the orientation unit, the audio output device, and the olfactory output device via the operating system, and is configured to obtain display and print settings for the display device and printing device, respectively, from the at least one software application.

32. The device of claim 30 wherein components and applications of the electronic device are configured to register with the sensitivity manager and to send specified data to the sensitivity manager based on configuration settings.

33. The device of claim 26 wherein the environmental attributes detector comprises at least one of a location/global positioning system for determining a location of use of the electronic device, a motion detector for detecting a presence of people, user interface input devices for the electronic device, ambient condition sensors for detecting ambient conditions at the location of use of the electronic device, and a camera.

34. The device of claim 33 wherein the sensitivity manager includes at least one of an image analyzer for receiving input from the camera and for performing facial recognition to identify people in a vicinity of the location of use of the electronic device, and an audio analyzer for receiving input from a microphone and for performing voice-recognition to identify people in the vicinity of the location of use of the electronic device.

35. An electronic device comprising:
an environmental attributes detector for monitoring attributes of a user environment in which a first instance of information related to a resource is presented to a user;
a resource attributes detector for determining attributes of the resource for which the first instance of information is presented;
a sensitivity manager in communication with the environmental attributes detector and the resource attributes detector, wherein when executed by the processor, the sensitivity manager functions to:
detect a user-initiated change in a presentation attribute of the instance of information;
store the user environment attributes and the changed presentation attribute in association with the resource following detection of the user-initiated change in the presentation attribute; and
automatically determine a sensitivity level of the resource based on the detected user-initiated change in the presentation attribute and the user environment attributes.

36. A system for automatically applying presentation attributes to a resource based on attributes of a user environment in which the resource is presented, the system comprising:
means for monitoring attributes of a user environment in which a first instance of information related to a resource is presented to a user;
means for detecting a change in an attribute of the user environment;
means for detecting a user-initiated change in a presentation attribute of the first instance of information following the detected change in the user environment attribute, the user-initiated change related to a presentation of the first instance of information;
means for associating the changed user environment attribute and the changed presentation attribute with the resource;
means for detecting a second instance of information related to the resource being presented to the user; and
means providing for the changed presentation attribute to be applied to the second instance of the information related to the resource when the associated user environment attribute is detected.
